(19) United States
(12) Patent Application Publication
(10) Pub. No.: US 2007/0052626 A1
(43) Pub. Date: Mar. 8, 2007

(54) PLASMA DISPLAY APPARATUS

(75) Inventors: Won Soon Kim, Gumi-si, Kyungsangbuk-do (KR); Oh Hun Kwon, Busan-si (KR); Kyoung Jin Jung, Gumi-si, Kyungsangbuk-do (KR); Yoon Chang Choi, Milyang-si, Kyungsangnam-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/424,090

(22) Filed: Jun. 14, 2006

(30) Foreign Application Priority Data
Sep. 7, 2005 (KR) 10-2005-0083341

(51) Int. Cl. G09G 3/28

(52) U.S. Cl. 345/68

(57) ABSTRACT

A plasma display apparatus is provided. The plasma display apparatus includes a first substrate, a second substrate, first and second electrodes formed on the first substrate, and a sustain driver for applying a sustain pulse to at least one of the first and second electrodes. The sustain pulse applied to at least one of the first and second electrodes has intermediate pulses having two or more shape between the first and last pulses. According to the plasma display apparatus, pulses of various shapes are applied to a plasma display panel (PDP) in a sustain period so that it is possible to adaptively improve energy efficiency, a sustain voltage margin, and a brightness characteristic.

### BACKGROUND OF THE INVENTION

1. Field of the Invention

The present invention relates to a plasma display apparatus, and more particularly, to a plasma display apparatus in which a plasma display panel (PDP) is adaptively driven considering energy efficiency and brightness characteristic.

2. Description of the Background Art

In a plasma display apparatus, discharge cells are formed between a lower substrate on which barrier ribs are formed and an upper substrate that faces the lower substrate and vacuum ultraviolet (VUV) generated when inert gases in the discharge cells are discharged by a high frequency voltage collides with phosphors to generate light so that an image is displayed.

FIG. 1 illustrates a common structure of a discharge cell of an alternate current (AC) surface discharge plasma display panel (PDP).

Two sheets of plane glass that form an upper substrate 10 and a lower substrate 18 are coated with a few necessary layers and are attached to each other to obtain the PDP. The upper substrate 10 faces the lower substrate 18. A scan electrode Y and a sustain electrode Z are formed on the upper substrate 10 and an address electrode X is formed on the lower substrate 18.

The scan electrode Y and the sustain electrode Z are composed of transparent electrodes 12Y and 12Z and metal bus electrodes 13Y and 13Z whose line width is smaller than the line width of the transparent electrodes. An upper dielectric layer 14 and a protective layer 16 are laminated on the upper substrate 10 to cover the scan electrode Y and the sustain electrode Z. Wall charges that are generated during plasma discharge are accumulated on the upper dielectric layer 14. The protective layer 16 prevents the upper dielectric layer 14 from being damaged by the sputtering that is generated during the plasma discharge and improves the emission efficiency of secondary electrons.

A lower dielectric layer 22 and barrier ribs 24 for preventing ultraviolet (UV) rays and visible rays that are generated by discharge from leaking to adjacent discharge cells are formed on the lower substrate 18. The surfaces of the lower dielectric layer 22 and the barrier ribs 24 are coated with a phosphor layer 26. The phosphor layer 26 is excited by the UV rays that are generated during the plasma discharge to generate one of the red, green, and blue visible rays.

FIG. 2 illustrates a method of time division driving the PDP such that one frame is divided into a plurality of sub fields. In order to implement the gray levels of an image, the PDP is time division driven such that one frame is divided into a plurality of sub fields having different number of times of emission. Each sub field is divided into a reset period for initializing the entire screen, an address period for selecting a scan line to select a discharge cell from the selected scan line, and a sustain period for implementing gray levels in accordance with discharge number of times.

For example, when an image is to be displayed by 256 gray levels, a frame period (16.67 ms) corresponding to 1/60 second is divided into eight sub fields SF1 to SF8 as illustrated in FIG. 2. When the gray levels are displayed using the eight sub fields, each of the eight sub fields SF1 to SF8 is divided into the reset period, the address period, and the sustain period.

Meanwhile the initialization period and the address period are the same in each of the sub fields, the sustain period and the number of sustain pulses that are assigned in the sustain period in each sub field increases in the ratio of 2ⁿ (n=0. 1. 2. 3. 4. 5. 6, and 7). Since the sustain period for implementing the gray levels in accordance with the discharge number of times in order to display the 256 gray levels varies with each sub field, each sub field can display gray levels of an image and an image frame is displayed by the combination of the sub fields.

FIG. 3 illustrates the shape of one period of a sustain pulse that is applied in the sustain period. One period of the sustain pulse is composed of an energy recovery up time (ER_up time), a sustain voltage sustaining time (Sus_up time), and an energy recovery down time (ER_down time).

As described above, in the conventional art, the shape of the sustain pulse that is applied in one sustain period, that is, the energy recovery up time, the energy recovery down time, and the sustain voltage sustaining time of the applied sustain pulse are fixed.

### SUMMARY OF THE INVENTION

In order to solve the problems of the conventional art, the present invention has been made in an effort to provide a plasma display apparatus in which sustain pulses are adaptively applied in a sustain period.

A plasma display apparatus according to the present invention includes a first substrate, a second substrate, first and second electrodes formed on the first substrate, and a sustain driver for applying a sustain pulse to at least one of the first and second electrodes. The sustain pulse applied to at least one of the first and second electrodes has intermediate pulses having two or more shape between the first and last pulses.

The shape of pulse is preferably defined by at least one of the energy recovery up time (ER_up time), the sustain voltage sustaining time, and the energy recovery down time (ER_down time) of the pulse.

The energy recovery up time (ER_up time) of the pulse preferably ranges from 350 ns to 800 ns. The sustain voltage sustaining time of the pulse preferably ranges from 400 ns to 3 μs.

The shapes of the pulses are preferably determined by at least one of an energy recovery rate, a number of expressed gray levels, a sustain voltage margin, a temperature, a luminance of an image to be displayed and an average picture level (APL) required for the plasma display apparatus.

The energy recovery up time (ER_up time), sustain voltage sustaining time and energy recovery down time (ER_down time) of the pulse are preferably determined by at least one of the energy recovery rate, the number of expressed gray levels, a sustain voltage margin, the temperature, the luminance of an image to be displayed and the average picture level (APL) required for the plasma display apparatus. The intermediate pulses are preferably a series of a plurality of pulses having two or more shapes being repeated.

Another plasma display apparatus according to the present invention includes a first substrate, a second substrate, first and second electrodes formed on the first substrate, and a sustain driver for applying a sustain pulses to the first and second electrodes. The pairs of two intermediate pulses applied to the first and second electrodes in an alternate manner have two or more patterns.

The pattern of the pair of two intermediate pulses is preferably determined by the respective shapes of the two intermediate pulses. The shape of pulse is preferably defined by at least one of the energy recovery up time (ER_up time), the sustain voltage sustaining time, and the energy recovery down time (ER_down time) of the pulse.

At least one of the patterns of the pair of two intermediate pulses is preferably the pattern in which the two intermediate pulses overlap. At least one of the patterns of the pair of two intermediate pulses is preferably the pattern in which transition regions of the two intermediate pulses overlap. The pairs of two intermediate pulses applied in an alternate manner to the first and second electrodes are preferably a series of combinations of two or more patterns being repeated.

### BRIEF DESCRIPTION OF THE DRAWINGS

FIG. 1 is a perspective view illustrating a common structure of a discharge cell of a plasma display panel (PDP);

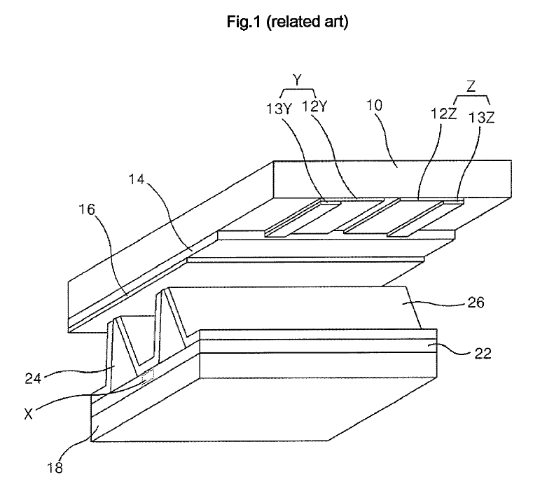

FIG. 2 illustrates a method of time division driving the PDP such that one frame is divided into a plurality of sub fields;

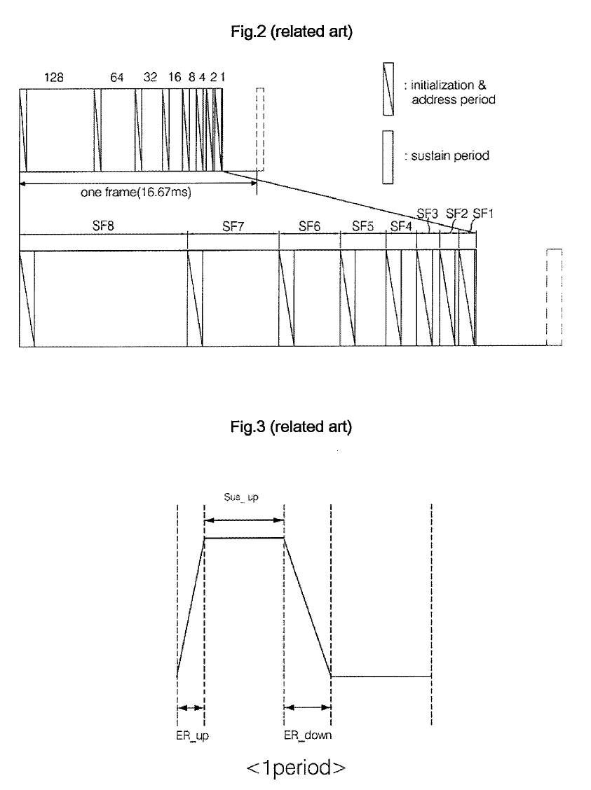

FIG. 3 is a timing diagram illustrating a common shape of a sustain pulse that is applied to electrodes in a sub field;

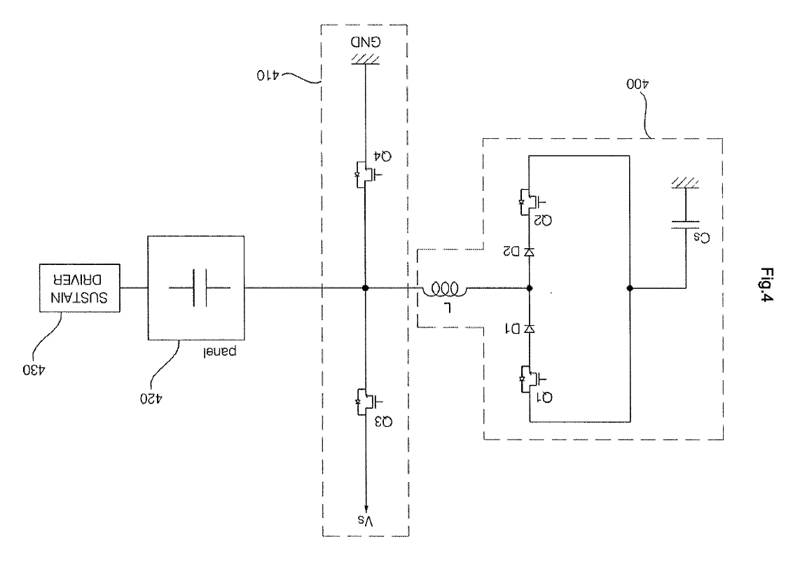

FIG. 4 is a circuit diagram illustrating an embodiment of a sustain driver included in a plasma display apparatus according to the present invention;

FIGS. 5A, 5B, 5C, and 5D illustrate embodiments of sustain pulses having different shapes that are applied to electrodes in a sustain period;

FIG. 6 is a timing diagram illustrating a first embodiment of sustain pulses that are applied to the PDP;

FIG. 7 is a timing diagram illustrating a second embodiment of sustain pulses that are applied to the PDP;

FIG. 8 is a timing diagram illustrating a third embodiment of sustain pulses that are applied to the PDP;

FIGS. 9A, 9B, and 9C are timing diagrams illustrating fourth embodiments of the sustain pulses that are applied to the PDP;

FIG. 10 illustrates an embodiment of different patterns of a pulse that is alternately applied to a scan electrode and a sustain electrode; and

FIGS. 11A, 11B, and 11C illustrate embodiments of a method of alternately applying pairs of pulses having different patterns to the scan electrode and the sustain electrode.

### DETAILED DESCRIPTION OF PREFERRED EMBODIMENTS

Preferred embodiments of a plasma display apparatus for driving a plasma display panel (PDP) using a sustain pulse having adaptive shapes according to the present invention will be described in detail with reference to the accompanying drawings.

The plasma display apparatus according to the present invention is not limited to the embodiments that are described in the present specification but a plurality of embodiments may exist.

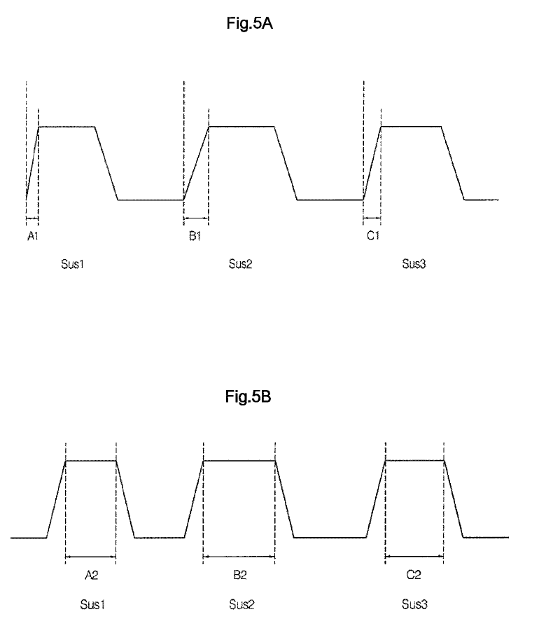

The embodiments of the present invention will be described in detail with reference to FIGS. 4 to 11.

In order to display an image on the PDP, one frame is divided into a plurality of sub fields to perform time division driving. Each of the sub fields is composed of a reset period for initializing discharge cells, an address period for determining an on cell in accordance with image data, and a sustain period for displaying an image by sustain discharge.

A sustain pulse is alternately applied to a scan electrode Y or a sustain electrode Z that are included in the PDP in the sustain period. Sustain discharge is generated between the scan electrode Y and the sustain electrode Z according as the sustain pulse is applied to display gray levels.

In general, the sustain pulse includes an energy recovery up section (ER_up) that rises from a low potential sustain voltage to a high potential sustain voltage, a sustain voltage up section (Sus_up) that sustains the high potential sustain voltage, and an energy recovery down section (ER_down) that falls from the high potential sustain voltage to the low potential sustain voltage.

FIG. 4 is a circuit diagram illustrating an embodiment of a sustain driver included in a plasma display apparatus according to the present invention. In the sustain driver, an energy recovery unit 400 is connected between a panel and a source capacitor Cs and includes an inductor L that forms a resonance circuit together with the panel and first and second switches Q1 and Q2 that are connected between the source capacitor Cs and the inductor L in parallel. The source capacitor Cs recovers energy that is charged in a panel capacitor during sustain discharge to charge the energy and supplies the charged energy to the panel capacitor.

A sustain pulse supply unit 410 is connected between the inductor L and the panel in parallel and includes a third switch Q3 that is connected to a sustain voltage source Vs to be turned on in order to supply a sustain voltage and a fourth switch Q4 that is connected to a ground GND to be turned on in order to reduce the voltage of the panel to a ground voltage.

That is, when the first switch Q1 is turned on, the energy that is charged in the source capacitor Cs is supplied to the panel capacitor so that the voltage of the sustain pulse that is supplied to the panel during an energy recovery up time (ER_up time) increases. Then, when the third switch Q3 is turned on, the voltage of the sustain pulse increases to the sustain voltage to be sustained during a sustain voltage sustaining time (Sus_up time).

When the second switch Q2 is turned on, the energy charged in the panel capacitor is recovered to the source capacitor Cs so that the voltage of the sustain pulse is reduced during an energy recovery down time (ER_down time). Then, when the fourth switch Q4 is turned on, the voltage of the sustain pulse is reduced to the ground voltage.

Therefore, signals for turning on and off the first to fourth switches Q1, Q2, Q3, and Q4 are controlled to change the shape of the applied pulse, that is, the energy recovery up time (ER_up time), the sustain voltage sustaining time (Sus_up time), and the energy recovery down time (ER_down time) of the pulse.

Among the pulses that are alternately applied to the scan electrode Y or the sustain electrode Z in the sustain period, the other intermediate pulses excluding the first pulse and the final pulse generally have the same shape. In the plasma display apparatus according to the present invention, the intermediate pulses among the sustain pulses are made to have two or more shapes using the above-described method.

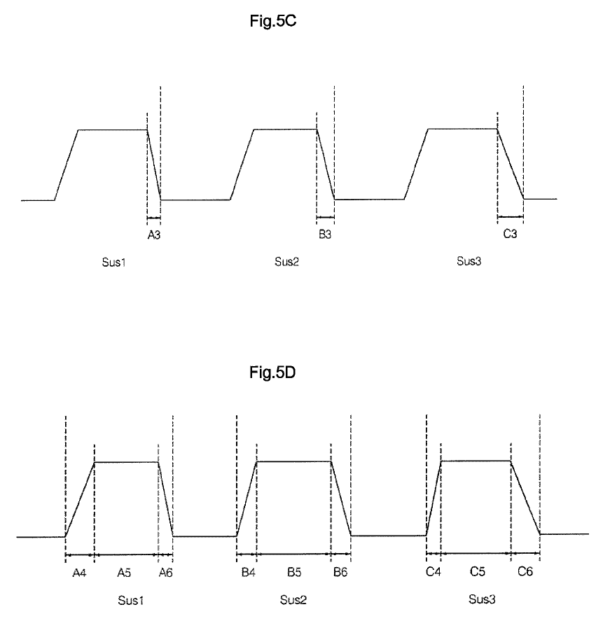

FIG. 5A illustrates a first embodiment of the two or more shapes that the intermediate pulses that are alternately applied to the scan electrode Y and the sustain electrode Z in the sustain period have. The energy recovery up time (ER_up time) of each pulse varies so that three different pulse shapes are obtained.

When the energy recovery up time (ER_up time) increases, the energy recovery rate of the sustain driver for supplying the sustain pulse to the PDP to drive the PDP increases. However, a sustain voltage margin is reduced and the brightness characteristic of a displayed image deteriorates. To the contrary, when the energy recovery up time (ER_up time) is reduced, the brightness characteristic is improved by the sustain discharge. However, the energy recovery rate deteriorates.

Therefore, it is preferable that the energy recovery up time (ER_up time) of the sustain pulse that is applied in one sub field be adaptively changed in accordance with the energy recovery rate, the brightness characteristic that is required by the plasma display apparatus, and the sustain voltage margin so that the intermediate pulses having two or more shapes are alternately applied to the scan electrode Y and the sustain electrode Z.

When the energy recovery up time (ER_up time) is too short, an increase in the voltage of the sustain pulse that is caused by energy recovery is too small so that a sudden change in electric potential is generated when the sustain voltage is applied after the energy recovery. As a result, the shape of the sustain pulse instantaneously rises so that the voltage of the sustain pulse is higher than the sustain voltage. Since the energy that can be supplied to the panel by the energy recovery is limited when the energy recovery up time (ER_up time) is too long, it is not necessary to make the energy recovery up time (ER_up time) too long. In general, since the energy recovery is completed within 800 ns, the energy recovery up time (ER_up time) preferably ranges from 350 ns to 800 ns.

Among the pulses Sus1, Sus2, and Sus3 having different shapes as illustrated in FIG. 5A, the pulse Sus1 whose energy recovery up time ER_up time is short secures a sufficient sustain voltage margin and guarantees a good brightness characteristic of an image. However, the energy recovery rate deteriorates. The pulse Sus2 whose energy recovery up time (ER_up time) is long secures a high energy recovery rate. However, the sustain voltage margin and the brightness characteristic of an image deteriorate. Therefore, the pulses Sus1, Sus2, and Sus3 having the three shapes as illustrated in FIG. 5A are combined with each other in accordance with the energy recovery rate, the sustain voltage margin, and the image brightness characteristic that are required by the plasma display apparatus in accordance with the current state of the plasma display apparatus to obtain a sustain pulse so that the obtained sustain pulse is applied to the scan electrode Y and the sustain electrode Z.

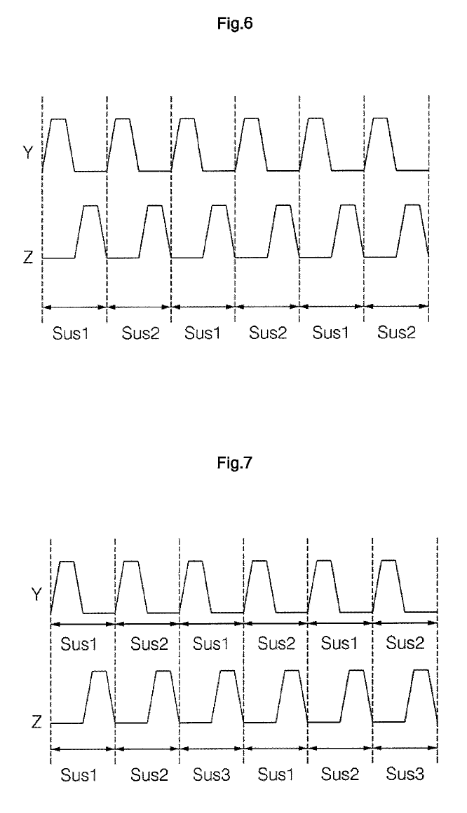

FIG. 6 is a timing diagram illustrating a first embodiment of sustain pulses that are applied to the PDP. The same sustain pulse is applied to the scan electrode Y and the sustain electrode Z. As illustrated in FIG. 6, among the pulses having the three shapes as illustrated in FIG. 5A, the pulse Sus1 having the energy recovery up time (ER_up time) of A1 and the pulse Sus2 having the energy recovery up time (ER_up time) of B1 are repeatedly applied.

When the pulse Sus1 is applied, since the energy recovery up time A1 is short, it is possible to improve the brightness characteristic. When the pulse Sus2 is applied, since the energy recovery up time B1 is long, it is possible to improve the energy recovery rate. Therefore, when the pulses Sus1 and Sus2 are repeatedly applied, it is possible to improve the energy recovery rate and to secure proper brightness.

As described above, according as the pulses having two or more different shapes are repeatedly applied to the scan electrode Y and the sustain electrode Z, it is possible to simultaneously improve the energy recovery rate and the brightness characteristic of the PDP.

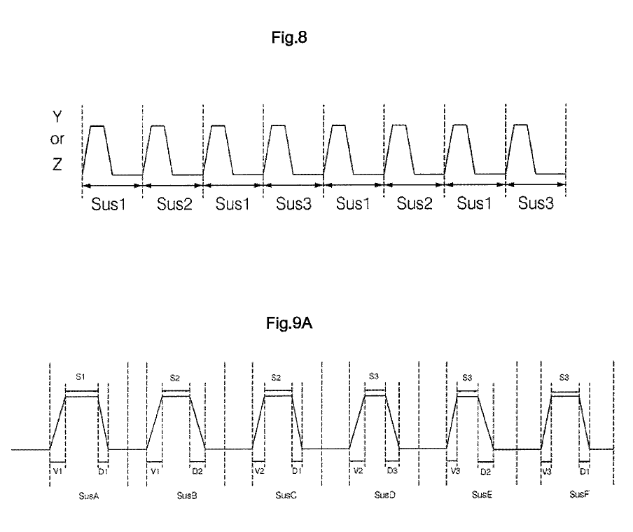

FIG. 7 is a timing diagram illustrating a second embodiment of sustain pulses that are applied to the PDP. Different sustain pulses are applied to the scan electrode Y and the sustain electrode Z. That is, the pulse Sus1 having the energy recovery up time (ER_up time) of A and the pulse Sus2 having the energy recovery up time ER_up time of B are sequentially applied to the scan electrode Y. The pulse Sus1, the pulse Sus2, and the pulse Sus3 having the energy recovery up time (ER_up time) of C are sequentially applied to the sustain electrode Z.

As described above, when the pulse Sus3 having the energy recovery up time (ER_up time) of a middle length is applied after the pulses Sus1 and Sus2 are applied, it is possible to secure the sustain voltage margin. That is, since the energy recovery up time (ER_up time) of the pulse Sus2 is long so that the sustain voltage margin is not sufficient to generate flickering by strong discharge, the pulse Sus3 having the energy recovery up time (ER_up time) of the middle length that is shorter than the energy recovery up time (ER_up time) of the pulse Sus2 is applied to secure the sustain voltage margin and to prevent flickering from being generated.

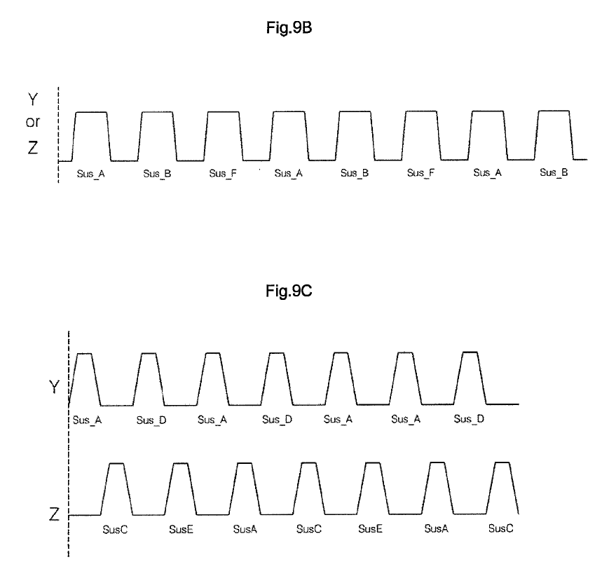

FIG. 8 is a timing diagram illustrating a third embodiment of sustain pulses that are applied to the PDP. The combination of the pulses having two or more different shapes is repeatedly applied to the scan electrode Y or the sustain electrode Z. As illustrated in FIG. 8, the sequential combination of the pulse Sus1, the pulse Sus2, and the pulse Sus3 is repeatedly applied to the scan electrode Y or the sustain electrode Z.

As described above, the pulse whose energy recovery up time (ER_up time) is short and the pulse whose energy recovery up time (ER_up time) is long are used and the pulse having the energy recovery up time (ER_up time) of a middle length between the lengths of the energy recovery up times the above two pulses may be used in accordance with the characteristic of the panel. The pulse having the energy recovery up time (ER_up time) of the middle length is added to the sustain pulse so that it is possible to recover the sustain voltage margin that was deteriorated by the increases in the energy recovery up time (ER_up time).

FIG. 5B illustrates a second embodiment of the two or more shapes of the intermediate pulses that are alternately applied to the scan electrode Y and the sustain electrode Z in the sustain period. The sustain voltage sustaining time (Sus_up time) of each pulse varies so that three different pulse shapes are obtained.

The sustain voltage sustaining time (Sus_up time) is preferably 400 ns to 3 μs. Since the high potential sustain voltage is applied during the sustain voltage sustaining time (Sus_up time) to generate discharge, the high potential sustain voltage no less than 400 ns is applied to sustain discharge. When the sustain voltage sustaining time (Sus_up time) is no more than 400 ns, a wall voltage in discharge cells is weak so that it is difficult to sustain discharge.

Therefore, since the time for which discharge is sustained increases according as the sustain voltage sustaining time (Sus_up time) increases, it is possible to stably perform the sustain discharge. However, since the number of sustain pulses that are applied in one sub field must be reduced when the sustain voltage sustaining time (Sus_up time) is too long, the sustain voltage sustaining time (Sus_up time) is made not to exceed 3 μs.

Since the period of the sustain pulse increases when the sustain voltage sustaining time (Sus_up time) is too long, the sustain pulses that can be applied in one sub field are limited so that it is difficult to display various gray levels.

Therefore, as illustrated in FIG. 5B, the pulse having two or more different sustain voltage sustaining times (Sus_up time) in accordance with the number of gray levels that are required by the plasma display apparatus to be displayed is used to form the sustain pulse.

The combination of the pulses having different sustain voltage sustaining times (Sus_up time) as illustrated in FIG. 5B is repeatedly applied so that the sustain pulses illustrated in FIGS. 6 to 8 may be applied to the scan electrode Y or the sustain electrode Z.

FIG. 5C illustrates a third embodiment of the two or more shapes that the intermediate pulses that are alternately applied to the scan electrode Y and the sustain electrode Z in the sustain period have. The energy recovery down time (ER_down time) of each pulse varies so that three different pulse shapes are obtained.

When the energy recovery down time (ER_down time) increases, the energy recovery rate of the sustain driver for supplying the sustain pulse to the PDP to drive the PDP increases. When the energy recovery down time (ER_down time) is reduced, the energy recovery rate is reduced. When the energy recovery down time (ER_down time) is too short, the energy recovery is not sufficiently performed. When the energy recovery down time (ER_down time) is too long, the energy that is recovered by the energy recovery is limited. Therefore, the energy recovery down time (ER_down time) preferably ranges from 350 ns to 800 ns.

The combination of the pulses having different energy recovery down times (ER_down time) as illustrated in FIG. 5C is repeatedly applied so that the sustain pulses illustrated in FIGS. 6 to 8 may be applied to the scan electrode Y or the sustain electrode Z.

FIG. 5D illustrates a fourth embodiment of the two or more shapes that that intermediate pulses that are alternately applied to the scan electrode Y and the sustain electrode Z in the sustain period have. The energy recovery up time (ER_up time), the sustain voltage sustaining time (Sus_up time), and the energy recovery down time (ER_down time) of each pulse vary.

In general, the energy recovery efficiency of the PDP is mainly affected by the large load of a screen and the brightness characteristic of the PDP is mainly affected by the small load of the screen.

Therefore, in the case where the screen load or the average picture level (APL) of the PDP is large, when the pulse having the energy recovery up time (ER_up time) or the energy recovery down time (ER_down time) no less than 550 ns is mainly used to form the sustain pulse, it is possible to improve the energy recovery efficiency of the PDP.

In the case where the screen load or the APL of the PDP is small, when the pulse having the energy recovery up time (ER_up time) or the energy recovery down time (ER_down time) no more than 600 ns is mainly used to form the sustain pulse, it is possible to improve the brightness characteristic of the PDP.

Therefore, the pulses having different energy recovery up times (ER_up time), sustain voltage sustaining times (Sus_up time), and energy recovery down times (ER_down time) are provided so that the above pulses are properly combined with each other in accordance with the characteristics of the PDP to obtain a sustain pulse and to apply the obtained sustain pulse to the scan electrode Y or the sustain electrode Z.

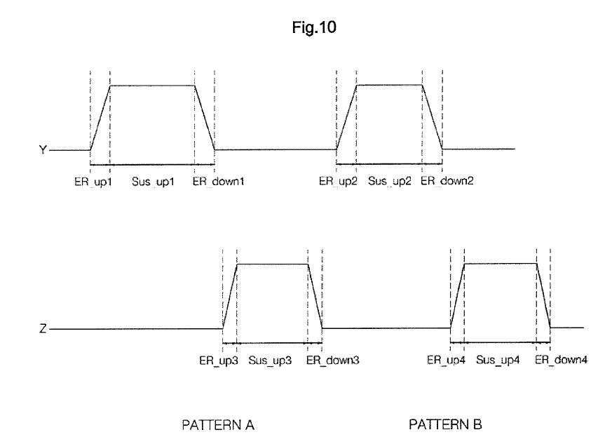

FIG. 9A illustrates pulses having six different shapes. s denotes the sustain voltage sustaining time (Sus_up time) and the magnitude of s is in the order of s₁>s₂>s₃. v denotes the energy recovery up time (ER_up time) and the magnitude of v is in the order of v₁>v₂>v₃. D denotes the energy recovery down time (ER_down time) and the magnitude of D is in the order of D₂>D₃>D₁. When the large energy recovery efficiency is required by the PDP, the pulse whose energy recovery up and down times (ER_up and down times) are long is selected. In order to recover the sustain voltage margin that is deteriorated by selecting the pulses whose energy recovery up and down times (ER_up and down times) are long, the pulse having middle energy recovery up and down times (ER_up and down times) may be combined.

That is, as illustrated in FIG. 9B, when it is necessary to improve the energy recovery efficiency and the brightness characteristic and to sustain the sustain voltage margin, it is preferable that the sustain voltage that is obtained by the combination of Sus_A+Sus_B+Sus_F be repeatedly applied to the scan electrode Y and the sustain electrode Z.

Also, as illustrated in FIG. 9C, the sustain pulse that is obtained by the combination of Sus_A+Sus_D may be repeatedly applied to the scan electrode Y and the sustain pulse that is obtained by the combination of Sus_C+Sus_E+Sus_A may be repeatedly applied to the sustain electrode Z.

As described above, the combination of the pulses having various shapes is repeatedly applied to the scan electrode Y or the sustain electrode Z so that the energy recovery is smoothly performed, the brightness characteristic is improved, and the sustain voltage margin is sustained.

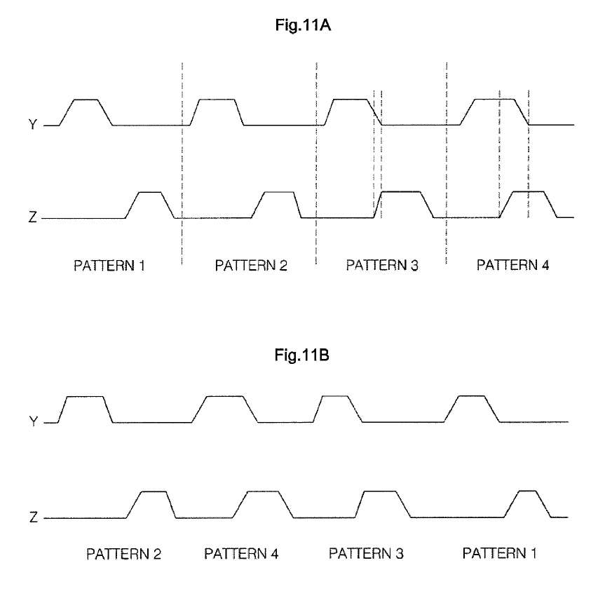

FIG. 10 illustrates an embodiment of different patterns of pulses that are alternately applied to the scan electrode and the sustain electrode. As described above, a pair of pulses are alternately applied to the scan electrode Y and the sustain electrode Z. As illustrated in FIG. 10, in the pattern 1, the pulse having the energy recovery up time of ER_up1, the sustain voltage sustaining time of SUS_up1, and the energy recovery down time of ER_down1 is applied to the scan electrode Y and the pulse having the energy recovery up time of ER_up2, the sustain voltage sustaining time of SUS_up2, and the energy recovery down time of ER_down2 is applied to the sustain electrode Z. In the pattern 2, the pulse having the energy recovery up time of ER_up3, the sustain voltage sustaining time of SUS_up3, and the energy recovery down time of ER_down3 is applied to the scan electrode Y and the pulse having the energy recovery up time of ER_up4, the sustain voltage sustaining time of SUS_up4, and the energy recovery down time of ER_down4 is applied to the sustain electrode Z.

In the sustain period, the pair of pulses having the above-described two or more different patterns are preferably applied to the scan electrode Y and the sustain electrode Z.

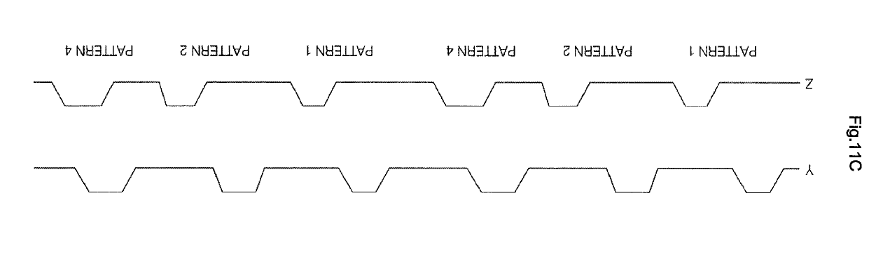

FIG. 11A illustrates an embodiment of four pairs of pulses having different patterns. In the pattern 3 illustrated in FIG. 11A, the transition region of the pulse that is applied to the scan electrode Y and the transition region of the pulse that is applied to the sustain electrode Z overlap each other. In the pattern 4 illustrated in FIG. 11A, the sustain voltage up section of the pulse that is applied to the scan electrode Y and the sustain voltage up section of the pulse that is applied to the sustain electrode Z overlap each other.

As illustrated in the patterns 3 and 4, when the transition region of the pulse that is applied to the scan electrode Y and the transition region of the pulse that is applied to the sustain electrode z overlap each other, the amount of change of a voltage increases so that strong discharge is generated between the two electrodes.

FIG. 11B illustrates the case in which the four different patterns that are illustrated in FIG. 11A are applied to the scan electrode Y and the sustain electrode Z in the order of the pattern 2, the pattern 4, the pattern 3, and the pattern 1.

FIG. 11C illustrates the case in which the sustain pulse that is obtained by the combination of the pattern 1, the pattern 2, and the pattern 4 among the four different patterns that are illustrated in FIG. 11A is repeatedly applied to the scan electrode Y and the sustain electrode Z.

As described above, the sustain pulse that is obtained by the combination of the pulses having various shapes is repeatedly applied to the scan electrode Y and the sustain electrode Z so that the energy recovery is smoothly performed, the brightness characteristic is improved, and the sustain voltage margin is sustained.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus, comprising:
a first substrate;
a second substrate;
first and second electrodes formed on the first substrate; and
a sustain driver for applying a sustain pulse to at least one of the first and second electrodes,
wherein the sustain pulse applied to at least one of the first and second electrodes has intermediate pulses having two or more shape between the first and last pulses.

2. The apparatus as claimed in claim 1, wherein the shape of pulse is defined by at least one of an energy recovery up time (ER_up time), a sustain voltage sustaining time, and an energy recovery down time (ER_down time) of the pulse.

3. The apparatus as claimed in claim 2, wherein the energy recovery up time (ER_up time) of the pulse ranges from 350 ns to 800 ns.

4. The apparatus as claimed in claim 2, wherein the sustain voltage sustaining time of the pulse ranges from 400 ns to 3 μs.

5. The apparatus as claimed in claim 2, wherein the energy recovery down time (ER_down time) of the pulse ranges from 350 ns to 800 ns.

6. The apparatus as claimed in claim 1, wherein the shapes of the pulses are determined by at least one of an energy recovery rate, a number of expressed gray levels, a sustain voltage margin, a temperature, a luminance of an image to be displayed and an average picture level (APL) required for the plasma display apparatus.

7. The apparatus as claimed in claim 2, wherein the energy recovery up time (ER_up time), sustain voltage sustaining time and energy recovery down time (ER_down time) of the pulse are determined by at least one of the energy recovery rate, the number of expressed gray levels, a sustain voltage margin, the temperature, the luminance of an image to be displayed and the average picture level (APL) required for the plasma display apparatus.

8. The apparatus as claimed in claim 1, wherein the intermediate pulses are a series of a plurality of pulses having two or more shapes being repeated.

9. The apparatus as claimed in claim 1, wherein the intermediate pulses are applied to the same electrode.

10. A plasma display apparatus, comprising:
a first substrate;
a second substrate;
first and second electrodes formed on the first substrate; and
a sustain driver for applying a sustain pulses to the first and second electrodes;
wherein the pairs of two intermediate pulses applied to the first and second electrodes in an alternate manner have two or more patterns.

11. The apparatus as claimed in claim 10, wherein the pattern of the pair of two intermediate pulses is determined by the respective shapes of the two intermediate pulses.

12. The apparatus as claimed in claim 11, wherein the shape of pulse is defined by at least one of an energy recovery up time (ER_up time), a sustain voltage sustaining time, and an energy recovery down time (ER_down time) of the pulse.

13. The apparatus as claimed in claim 12, wherein the energy recovery up time (ER_up time) of the pulse ranges from 350 ns to 800 ns.

14. The apparatus as claimed in claim 12, wherein the sustain voltage sustaining time of the pulse ranges from 400 ns to 3 μs.

15. The apparatus as claimed in claim 12, wherein the energy recovery down time (ER_down time) of the pulse ranges from 350 ns to 800 ns.

16. The apparatus as claimed in claim 11, wherein the shapes of the pulses are determined by at least one of an energy recovery rate, a number of expressed gray levels, a sustain voltage margin, a temperature, a luminance of an image to be displayed and an average picture level (APL) required for the plasma display apparatus.

17. The apparatus as claimed in claim 12, wherein the energy recovery up time (ER_up time), sustain voltage sustaining time and energy recovery down time (ER_down time) of the pulse are determined by at least one of the energy recovery rate, the number of expressed gray levels, a sustain voltage margin, the temperature, the luminance of an image to be displayed and the average picture level (APL) required for the plasma display apparatus.

18. The apparatus as claimed in claim 10, wherein at least one of the patterns of the pair of two intermediate pulses is the pattern in which the two intermediate pulses overlap.

19. The apparatus as claimed in claim 18, wherein at least one of the patterns of the pair of two intermediate pulses is the pattern in which transition regions of the two intermediate pulses overlap.

20. The apparatus as claimed in claim 10, wherein the pairs of two intermediate pulses applied in an alternate manner to the first and second electrodes are a series of combinations of two or more patterns being repeated.
